(19) United States
(12) Patent Application Publication
(10) Pub. No.: US 2008/0159556 A1
(43) Pub. Date: Jul. 3, 2008

(54) METHOD TO CONTROL ENTERTAINMENT DISPLAY DEVICE

(76) Inventors: Aaron Ambrose, Raymond, OH (US); Michael Pilgrim, Raymond, OH (US); John Vilkinofsky, Raymond, OH (US); Steven Feit, Raymond, OH (US)

Correspondence Address: BROUSE MCDOWELL LPA, 388 SOUTH MAIN STREET, SUITE 500, AKRON, OH, 44311, US

(21) Appl. No.: 11/964,895

(22) Filed: Dec. 27, 2007

Related U.S. Application Data
(60) Provisional application No. 60/878,039, filed on Dec. 29, 2006.

(51) Int. Cl. H04B 1/00

(52) U.S. Cl. 381/86

(57) ABSTRACT

Various embodiments are provided for automatically closing a vehicle display device. In one embodiment, it is automatically closed only if the presence of an impediment to closure is not detected. In another embodiment, it is automatically closed when an impending vehicular collision is sensed. In yet another embodiment, it is automatically closed only if a vehicle reverse control device has been in the reverse condition for at least a predetermined time period.

This application claims priority from U.S. Ser. No. 60/878,039, titled Method to Control Entertainment System, filed Dec. 29, 2006, which is herein incorporated by reference.

### I. BACKGROUND OF THE INVENTION

A. Field of Invention

This invention pertains to the art of methods and apparatuses regarding the manufacture, assembly and operation of vehicle entertainment systems, and more particularly to methods and apparatuses regarding the control and adjustment of entertainment display devices.

B. Description of the Related Art

It is known in the automotive industry to provide vehicles with an entertainment system that comprises audio devices, audio-visual devices, and a display device. Vehicular entertainment systems allow passengers to listen to and/or view various forms of media while in the vehicle by using audio speakers and a display device. The display device may be attached to a ceiling-mounted housing receptacle, located atop a center console positioned between the driver and passenger front seats, or positioned behind the driver and/or passenger front seat headrests. One example of a rear-seat entertainment system is provided in U.S. Pat. No. 7,190,798 ENTERTAINMENT SYSTEM FOR A VEHICLE, which is incorporated herein by reference.

It is known in the automotive industry to provide for the automatic closing of the display device of an entertainment under certain conditions. The term automatic refers to the entertainment system's capability of initiating and performing the closing of the display device independently or without the need for a specific user-initiated action. Automatic closing of the display device allows the display device to close without a vehicle occupant taking any action directly intended to cause the display device to close such as pushing a button, toggling a switch, etc.

One disadvantage to known rear-seat entertainment display devices attached to a ceiling-mounted housing receptacle is the impairment of the driver's field of vision when the display is in the open position and the driver is operating the vehicle in reverse. It is known in the automobile industry to use an automatic display closing system to close the rear-seat entertainment display device into a stowed position inside the ceiling-mounted housing receptacle when the vehicle transmission engages a reverse gear. Current display closing systems, however, are unable to distinguish between a transmission lever placed in a reverse-gear position in order to engage reverse gear and a transmission lever “cycling-through” a reverse-gear position as an operator moves the transmission lever from the parked or “P” position, past the reverse or “R” position, and into the drive or “D” position.

Another disadvantage to known rear-seat entertainment displays attached to a ceiling-mounted housing receptacle and equipped with an automatic display closing system, is the inability to detect impediments. A vehicle passenger may, for example, inadvertently place his/her finger in such a position that it will impair the closing of the entertainment display device upon occurrence of a condition causing the automatic retraction of the rear-seat entertainment display. In this case, the passenger's finger may be injured.

Another disadvantage to known vehicle entertainment systems is related to vehicular collisions. In a vehicular collision, a rear-seat entertainment display in the open position creates an additional hazard for vehicle passengers. The collision may cause the rear-seat entertainment display to suddenly break from its support housing and become a harmful projectile traveling through die vehicle's passenger compartment or may cause injury when a vehicle passenger is propelled into it. Current rear-seat entertainment displays are unable to retract automatically upon detection of an imminent collision.

What is needed is a system that automatically closes a display device upon detecting an imminent vehicular collision, prevents the undesired closing of a display device when cycling through a reverse condition, and ceases closing the entertainment display upon detection of impairments.

### II. SUMMARY OF THE INVENTION

According to one embodiment of this invention, a method includes the steps of providing a vehicle with a closable display device having a means for determining the presence of an impediment to closure of the closable display device, initiating the closure of the closable display device, and automatically closing the closable display device only if the presence of an impediment to closure is not detected during the automatic closure of the closable display device. The closable display device may be an integrated closable display device.

According to another embodiment of this invention, a method includes the steps of providing a vehicle with an entertainment system that has a closable display device having a means for determining the presence of an impediment to closure of the closable display device, initiating the closure of the closable display device, and automatically closing the closable display device only if the presence of an impediment to closure is not detected during the automatic closure of the closable display device.

According to another embodiment of this invention, a method includes the steps of providing a vehicle with a closable display device having a means for determining the presence of an impediment to closure of the closable display device, sensing a passenger position in the vehicle, opening the closable display device to a predetermined position based upon the sensed passenger position, initiating the closure of the closable display device, and automatically closing the closable display device only if the presence of an impediment to closure is not detected during the automatic closure of the closable display device.

According to another embodiment of this invention, a method comprises the steps of providing a vehicle with a closable display device comprising a means for determining the presence of an impediment to closure of the closable display device, initiating the closure of the closable display device, and automatically closing the closable display device only if the presence of an impediment to closure is not detected during the automatic closure of the closable display device. The presence of an impediment to closure of the closable display device may be detected by determining that the change in velocity of the closable display device, measured by a sensor that detects a rotational rate of an electric motor, is less than a predetermined limit.

According to another embodiment of this invention, a method comprises the steps of providing a vehicle with a closable display device comprising a means for determining the presence of an impediment to closure of the closable display device, initiating the closure of the closable display device, and automatically closing the closable display device only if the presence of an impediment to closure is not detected during the automatic closure of the closable display device. The closable display device may be automatically closed through the use of a motor unless an applied motor torque exceeds a predetermined limit.

According to another embodiment of this invention, a method includes the steps of providing a vehicle with an entertainment system that has an integrated closable display device having a means for determining the presence of an impediment to closure of the closable display device, initiating the closure of the closable display device by operating a remote control device, and automatically closing the closable display device only if the presence of an impediment to closure is not detected during the automatic closure of the closable display device. The closable display device is automatically closed unless the change in velocity of the display device measured by a sensor that detects a rotational rate of an electric motor is less than a first predetermined limit or a motor torque exceeds a second predetermined limit.

According to another embodiment of this invention, a method includes the steps of providing a vehicle with a closable display device, sensing an impending vehicular collision, and automatically closing the closable display device.

According to another embodiment of this invention, a method includes the steps of providing a vehicle with an entertainment system that has a closable display device, sensing an impending vehicular collision, and automatically closing the closable display device.

According to another embodiment of this invention, a method includes the steps of providing a vehicle with an entertainment system that has an audio visual device and a closable display device, sensing an impending vehicular collision, and automatically closing the closable display device.

According to another embodiment of this invention, a method includes the steps of providing a vehicle with a closable display device, sensing an impending collision by using a sensor attached to the vehicle to detect the impending collision, and automatically closing the closable display device.

According to another embodiment of this invention, a method includes the steps of providing a vehicle with a closeable display device, sensing an impending vehicular collision, and automatically applying at least a first torque to pivot the closable display device into a closed position.

According to another embodiment of this invention, a method includes the steps of providing a vehicle with a closeable display device, sensing an impending vehicular collision, and automatically causing electric motor assembly to apply at least a first torque to pivot the closable display device into a closed position.

According to another embodiment of this invention, a method includes the steps of providing a vehicle with a closeable display device, detecting the vehicle being put in reverse, and automatically closing the closable display device if the vehicle has been in reverse for at least a predetermined time period.

According to another embodiment of this invention, a method includes the steps of providing a vehicle with an entertainment system that has a closable display device, detecting the vehicle being put in reverse, and automatically closing the closable display device if the vehicle has been in reverse for at least a predetermined time period.

According to another embodiment of this invention, a method includes the steps of providing a vehicle with an entertainment system that has an audiovisual device and a closable display device, detecting the vehicle being put in reverse, and automatically closing the closable display device if the vehicle has been in reverse for at least a predetermined time period.

According to another embodiment of this invention, a method includes the steps of providing a vehicle with a closeable display device, detecting the vehicle being put in reverse, and averting closing of the closable display device if the vehicle has been in reverse for less than a predetermined time period.

According to another embodiment of this invention, a method includes the steps of providing a vehicle with a closeable display device, detecting that the vehicle has been put into reverse at least in part by determining the position of a gear shift lever, and automatically closing the closable display device if the vehicle has been in reverse for at least a predetermined time period.

According to another embodiment of this invention, a method includes the steps of providing a vehicle with a closeable display device, detecting that the vehicle has been put into reverse, and automatically applying at least a first torque to pivot the closable display device into a closed position if the vehicle has been in reverse for at least a predetermined time period.

According to another embodiment of this invention, a method includes the steps of providing a vehicle with a closeable display device, detecting that the vehicle has been put into reverse, and automatically causing an electric motor assembly to apply at least a first torque to pivot the closable display device into a closed position if the vehicle has been in reverse for at least a predetermined time period.

One advantage of this invention is that upon detection of an imminent vehicular collision, the display device is automatically closed. In the event of a vehicular collision, it is desirable to have the display device in a closed position. A display device in an open position may present a substantial risk to vehicle occupants either as an obstruction or, if becoming dislodged during the collision, as a projectile. Often vehicle collisions happen unexpectedly and leave little time for the display device to be closed by an occupant. It is therefore desirable to have an apparatus which, upon detection of the vehicle collision, causes the display device to close without the need for operator input.

Another advantage of this invention is that undesired closings of the display device are prevented when the vehicle is cycled through a reverse condition. Various situations exist where the operator of the vehicle desires to change from a “Drive” gear to a “Park” gear or change from a “Park” gear to a “Drive” gear without closing the display device. One example may include a “traffic jam” scenario wherein the operator is prevented from traveling any further on a roadway for a certain period. Therefore, it is desirable to have a system that is able to prevent closure of the display device due to the vehicle being “cycled through” a reverse condition.

Another advantage of this invention is that closure of the display device is stopped upon detecting a “pinch condition.” Situations may arise wherein closure of the display device will cause an occupant's finger, hand, or any other object, to be pinched or caught between the display device and the apparatuses base. This pinching may cause injury to the occupant and it is therefore desirable to have a system wherein closure of the display device ceases upon detection of such a pinch condition.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view from within a vehicle showing a vehicle entertainment system according to one embodiment of the invention.

FIG. 2 is a perspective view of a display device according to one embodiment of the invention.

FIG. 3 is a functional block diagram of a vehicle entertainment system according to one embodiment of lie invention.

FIG. 4 is a perspective top view of a closable display device shown in a stowed or closed position according to one embodiment of the invention.

FIG. 5 is a perspective bottom view of the closeable display device shown in FIG. 4.

FIG. 6 is a perspective side view of the closeable display device shown in FIG. 4.

FIG. 7 is a perspective bottom view of the closeable display device shown in FIG. 4.

FIG. 8 is a perspective side view similar to that shown in FIG. 6 but showing the display device in an open position according to one embodiment of the invention.

FIG. 9 is a block diagram illustrating a control circuitry for a vehicle entertainment system according to one embodiment of the invention.

FIG. 10 is a perspective side view showing an operating panel that is capable of being positioned in a vehicle front console according to one embodiment of the invention.

FIG. 11 is a perspective view from within a vehicle showing a vehicle entertainment system according to another embodiment of the invention.

FIG. 12 is a perspective view of the interior of a vehicle showing a gear lever according to one embodiment of the invention.

FIG. 13 is a perspective view of the interior of a vehicle showing an ignition switch according to one embodiment of the invention.

### IV. DETAILED DESCRIPTION OF THE INVENTION

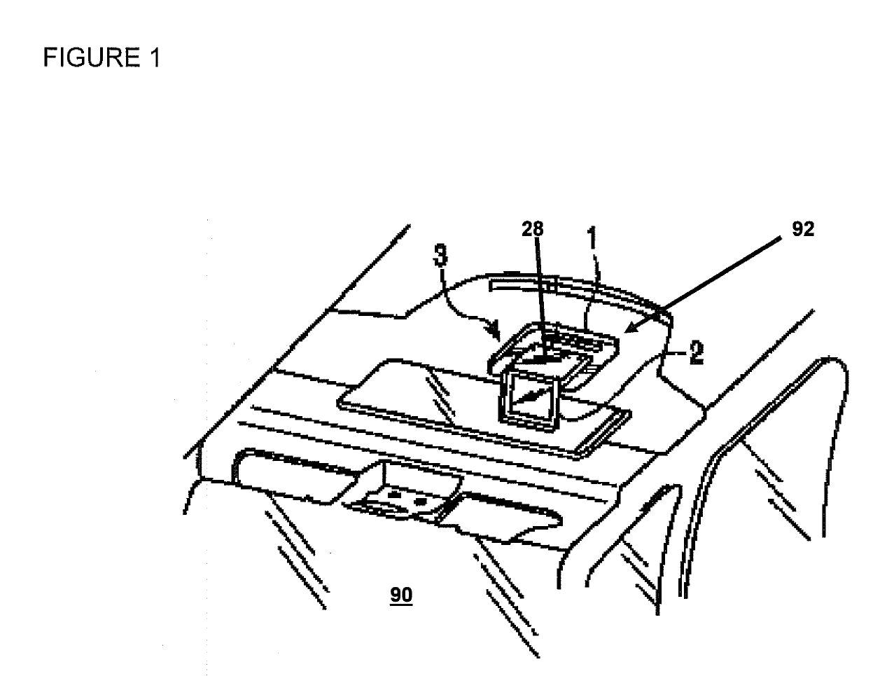

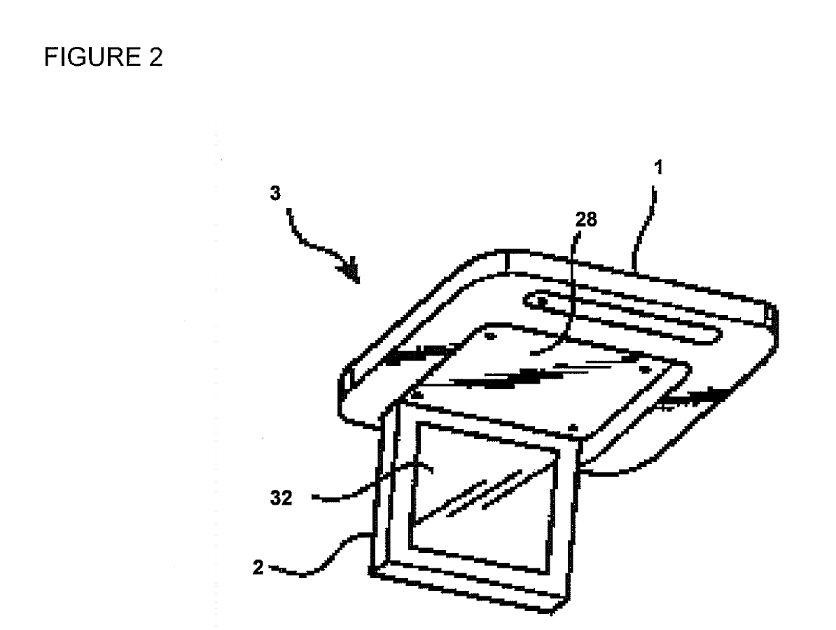

Referring now to the drawings wherein the showings are for purposes of illustrating embodiments of the invention only and not for purposes of limiting the same, FIGS. 1-3, generally show portions of a vehicle 90, from the inside, comprising a vehicle entertainment system 92 according to one embodiment of the present invention. The vehicle entertainment system 92 may comprise a display system 3, a driving mechanism 4, a status detection portion 5, and a control circuit 6. The display system 3 may comprise a mounting portion 1, a display device 2, and a hinge structure 16. The driving mechanism 4 enables, at least in part, the movement of the display device 2. The status detection portion 5 detects, at least in part, the status of at least one component of the vehicle 90 and may, in one embodiment, output a detection signal to the control circuit 6. The status detection portion 5 may be installed at a predetermined position in the vehicle, chosen with sound engineering judgment, suitable for detecting the status of at least one component of the vehicle entertainment system 92. The control circuit 6 may control the operation of the driving mechanism 4 in response to a detection signal outputted from the status detection portion 5.

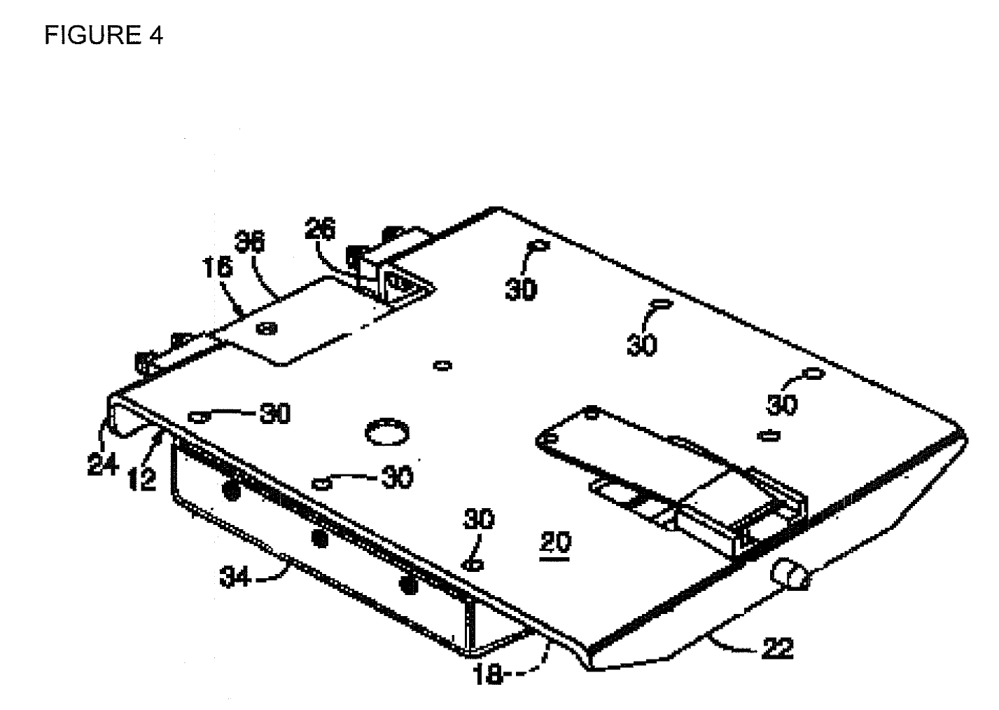

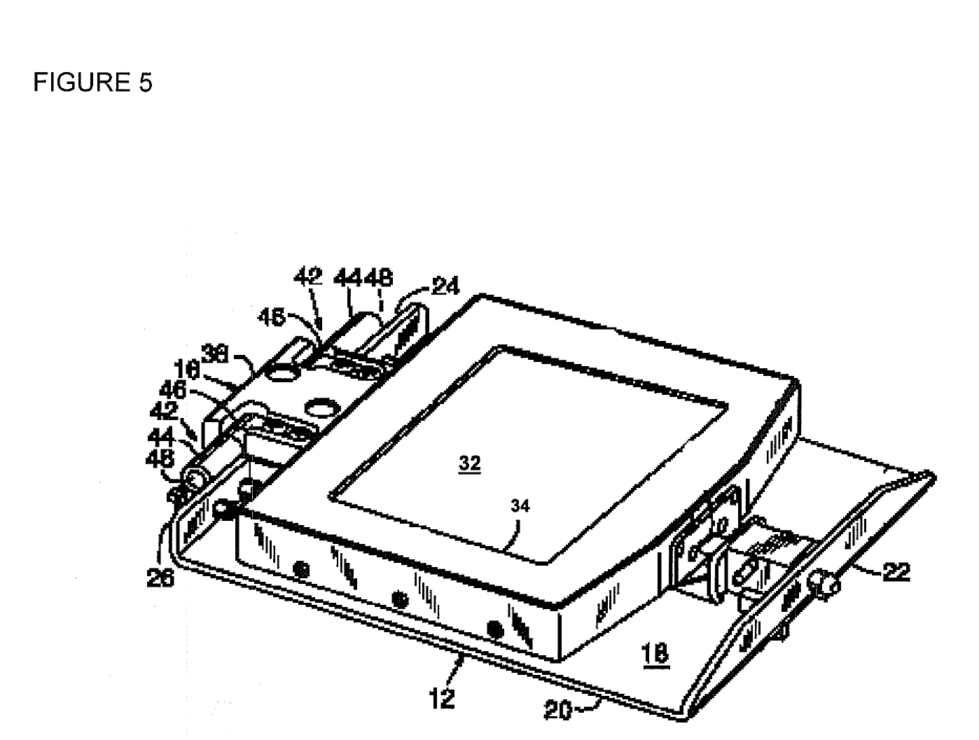

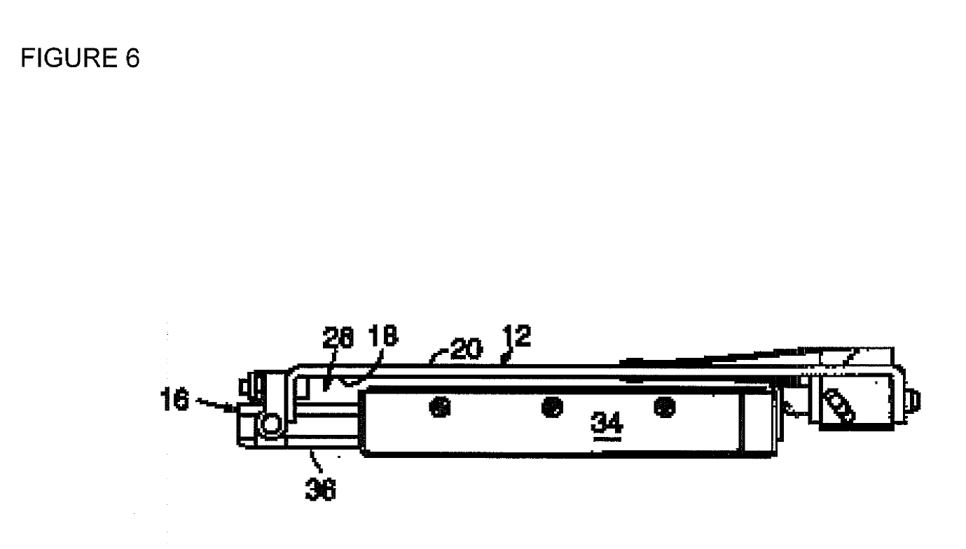

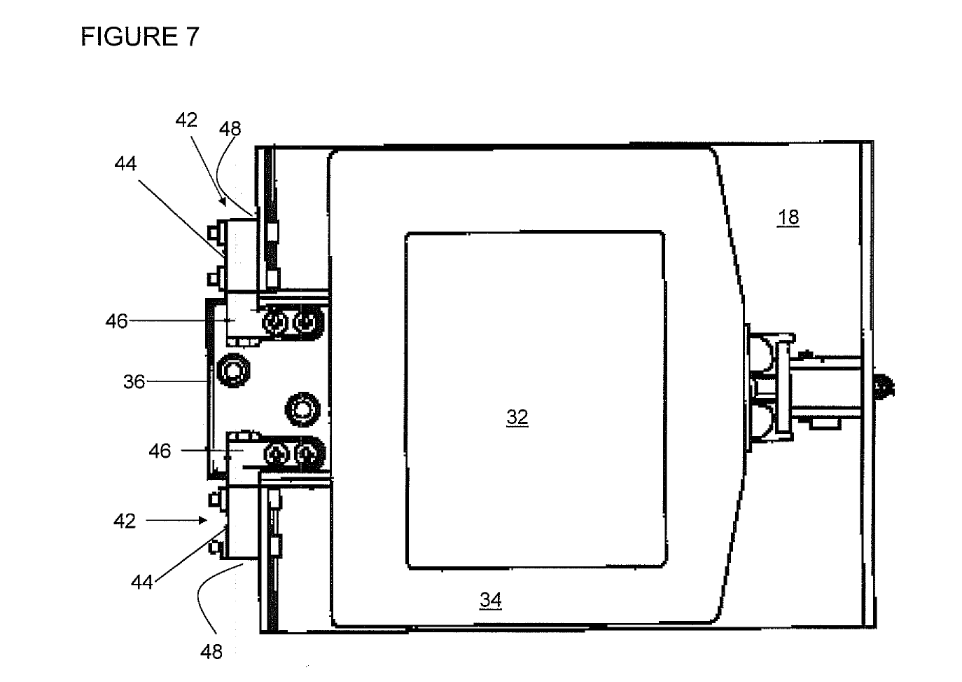

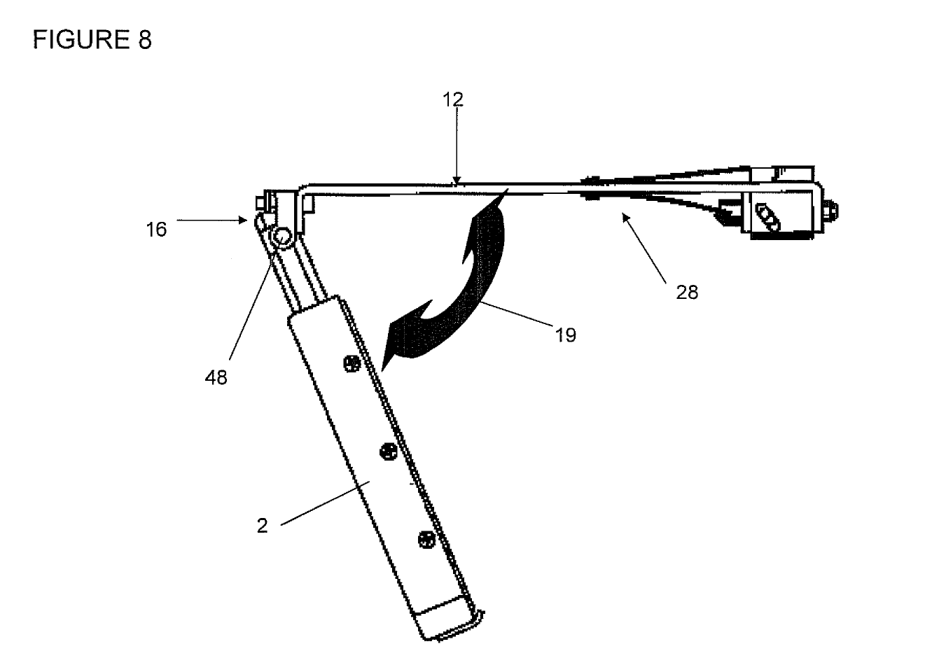

With reference now to FIGS. 1-8, the display system 3 will be described according to one embodiment of the invention. The mounting portion 1 may comprise a base 12. The base 12 may have a generally planar configuration and may include a lower surface 18, an upper surface 20, a forward edge portion 22, a first rearward edge portion 24, and a second rearward edge portion 26. The first rearward edge portion 24 may be positioned apart from the second rearward edge portion 26. The edge portions 22, 24, 26 extend away from the lower surface 18 to generally define a cavity 28. The display device 2 may be secured in the cavity 28 in its closed or stowed position. The base 12 may be mounted on a selected vehicle mounting surface. In one embodiment, the selected mounting surface is an overhead, generally planar surface, such as the ceiling of the passenger compartment of the vehicle 90. The base 12 may include a plurality of spaced apart mounting holes 30 through which conventional fasteners, such as screws or bolts, may be passed through to secure the display system 3 to the selected mounting surface. However, it is to be understood that the display system 3 may be secured to the selected mounting surface by any method chosen with sound engineering judgment.

With continuing reference to FIGS. 1-8, the display device 2 may include a display screen 32 through which images and other information may be conveyed to a viewer; a display housing portion 34 within which the display screen 32 may be located; and a neck portion 36 that may at least in part enable the pivotal movement of the display device 2. The display screen 32 may serve as a television screen, a computer screen, a video game display, or any other device used in displaying visual or audio-visual information to a viewer. The neck portion 36 may extend away from a housing 34 toward the rearward edge portions 24 and 26 of base 12.

With continuing reference to FIGS. 1-8, the hinge structure 16 may pivotally connect the display device 2 to the base 12 and enable the display device 2 to pivot within a predetermined range of motion or positions. According to one embodiment, the range of positions may include motion from a stowed or closed position, in which display device 2 is retained proximate to the base 12 and substantially within cavity 28; to a deployed position, in which display device 2 is pivoted away from the stowed or closed position such as to a user-viewable orientation. Typical user-viewable orientations may comprise positions wherein the display device 2 is positioned at an angle 19. Commonly, the angle 19 may be between approximately 45 degrees and approximately 90 degrees with respect to the plane of the base 12. The angle 19 may be greater or less than this range due to the shape and size of the passenger compartments and the number of viewing passengers and due to the specific application of the invention being utilized. The display device 2 in its stowed or closed position extends generally parallel to the plane of the base 12. The hinge structure 16 may include any conventional structure for joining and enabling pivotal movement of a pair of members such as the base 12 and the display device 2, chosen with sound engineering judgement. The hinge structure 16 may have sufficient resistance or Frictional force to prevent normal vehicle operation from causing the display device 2 from moving from a specific user-viewable orientation. However, the hinge structure 16 may allow the display device 2 to yield or retract if impacted by a passenger or other object such as that which may occur in an emergency situation or when a passenger is exiting the vehicle.

With continuing reference to FIGS. 1-8, in one embodiment, the hinge structure 16 may include a pair of hinges 42 each having first hinge elements 44 and second hinge element 46. Each of the first hinge elements 44 may be secured to one of the rearward edge portions 24, 26, and the second hinge elements 46 may be secured to the neck 36 of the display device 2. The first hinge element 44 and the second hinge element 46 are pivotally joined by a pin 48, about which the hinge elements 44, 46 rotate to enable the pivotal movement of the display device 2 with respect to the base 12.

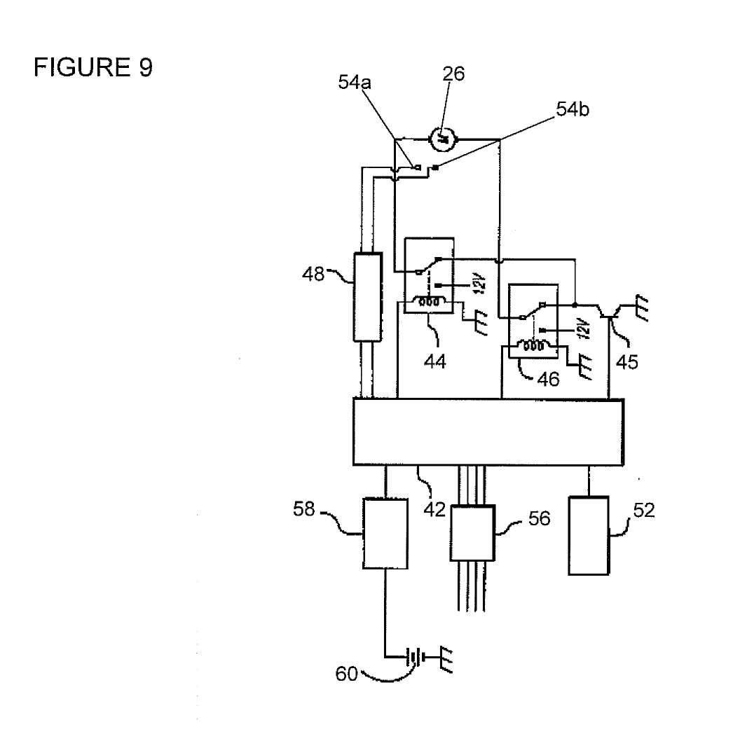

With reference now to FIGS. 1-3, and 9, the control circuit 6 may comprise a CPU 42, a non-volatile memory 52, and a switch input interface 56. The CPU 42 may control the operation of the display device 2, and may include a microprocessor, a microcontroller, an application specific integrated circuit or other like electronic device chosen with sound engineering judgment. The non-volatile memory 52 may comprise read only memory (ROM) or electrically eraseable programmable read only memory (EEPROM) and may provide stored instructions and other data utilized by the CPU 42. The CPU 42 is may be coupled to the switch input interface 56. The switch input interface 56 may receive signals from switches disposed in various locations chosen with sound engineering judgment and used to command the opening and closing of the display device 2. The CPU 42 may also be coupled to the voltage regulator 58 in order to detect a pinched condition as described below. Persons of ordinary skill will recognize that the control circuit 6 may be realized by controlling a computer with software. The type and/or the configuration of the hardware and software comprising the control circuit 6 may take any form chosen with sound engineering judgment and is not meant to serve as a limiting feature to the invention. Therefore, virtual circuit blocks are used to describe systems that may be used to implement the individual functions of the invention. The CPU 42 may include a reverse gear determination portion 61, a key determination portion 62, an equipment status determination portion 63, a close operation instructing portion 64, an open operation instructing portion 65, an anti-pinch determination portion 66, an impending vehicular collision determination portion 67, a passenger position determination portion 69 and a power supply switch portion 68. The close operation instructing portion 64 and the open operation instructing portion 65 may output a signal for operating a motor 26 in response to results determined by the reverse gear determination portion 61, the key determination portion 62, the anti-pinch determination portion 66, the impending vehicular collision determination portion 67, and the equipment status determination portion 63, or in response to an instruction entered via the operation panel 5f.

With continuing reference to FIGS. 1-3, and 9, the driving mechanism portion 4 may comprise a motor 26, a transmission portion 27, a voltage regulator 58, a pair of Hall sensor elements 54a, 54b, a Hall sensor interface 48, an opening relay 44, and a closing relay 46. The transmission portion 27 may allow for the transmitting of power from the motor 26 to the shaft of the display device 2. The voltage regulator 58 may regulate the DC power provided by a vehicle battery 60 and the Hall sensor elements 54a, 54b.

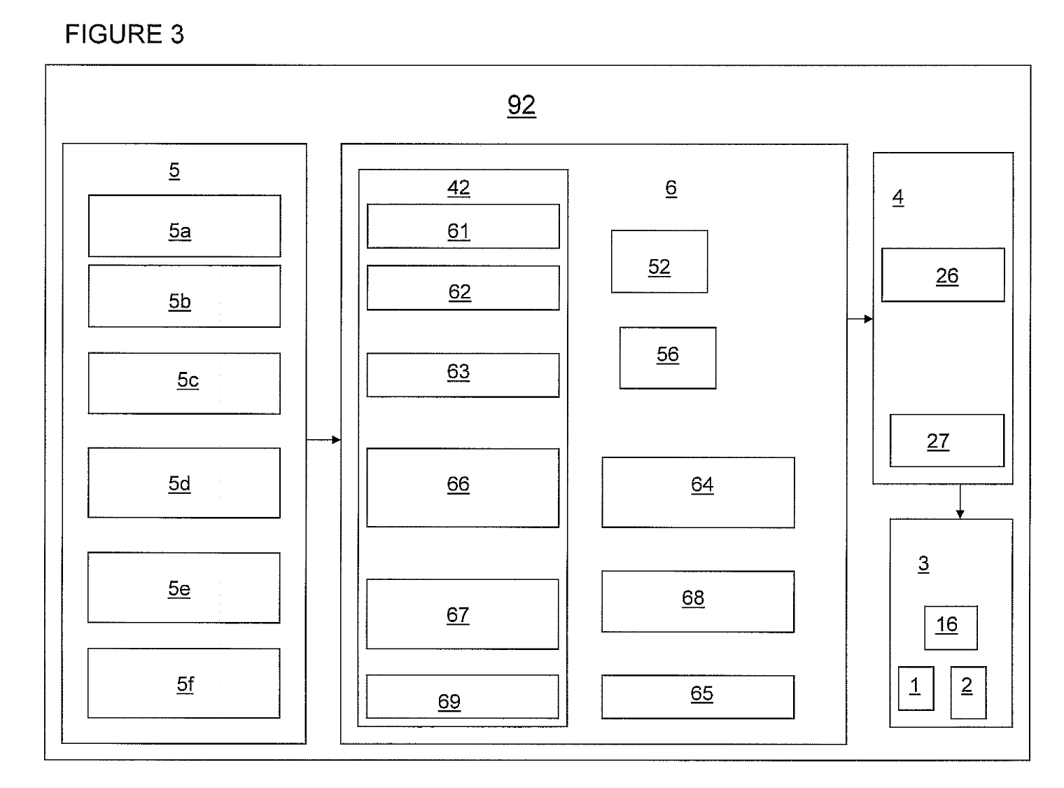

With reference now to FIG. 3, the status detection portion 5 may detect the status of any on-vehicle component. The status detection portion 5 may include one or more of the following sensors: a reverse sensing system 5a, a key sensor 5b, a collision sensor 5c, and a passenger position sensor 5d as well as a signal output portion 5e and an operation panel 5f. The status of any known vehicle component may be detected by the status detection portion 5 and the components listed are not intended to limit the scope of the invention.

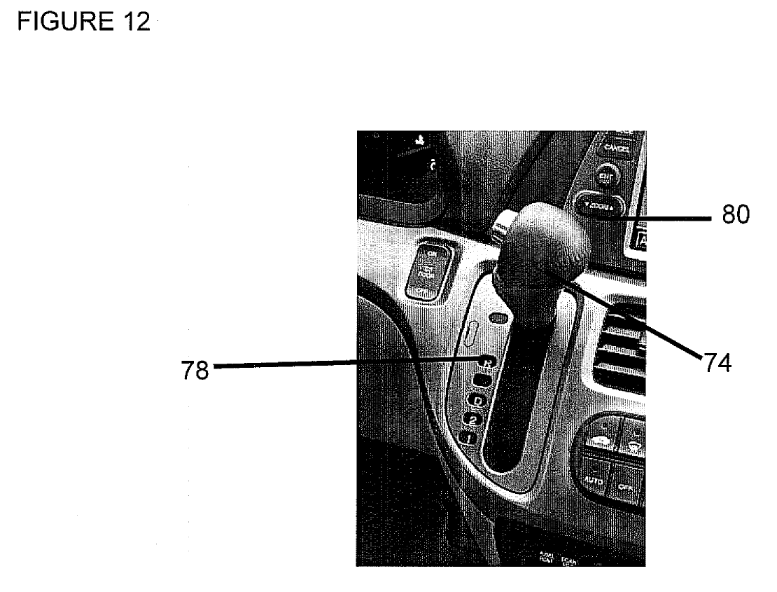

With reference now to FIGS. 3 and 12, the reverse sensing system 5a may detect that the vehicle 90 has been put in reverse in any manner applied with a sound engineering judgment. The reverse sensing system 5a may comprise, for example, a sensor for detecting the activation of a reverse gear signaling device such as the activation of vehicle reverse lights. In another nonlimiting example, the reverse sensing system 5a may comprise an audible alarm that may have a sensor that is disposed near a transmission gear adjustment lever 74, in order to detect its positioning. The reverse sensing system 5a may output a substantially continuous detection signal to the control circuit 6 when the vehicle is put in reverse such as when the transmission gear adjustment lever 74 is positioned into a reverse gear selection position 78. The reverse gear determination portion 61 may then determine whether the duration of the substantially continuous detection signal being output by the reverse sensing system 5a exceeds a predetermined value. Examples of predetermined values according to one embodiment, may include a range from about 0.2 seconds to about 1.5 seconds and a range from about 0.5 seconds to about 1.2 seconds. A person of ordinary skill in the art will be able to determine additional ranges suitable for this invention without undue experimentation and the ranges listed are not intended to limit the scope of the invention.

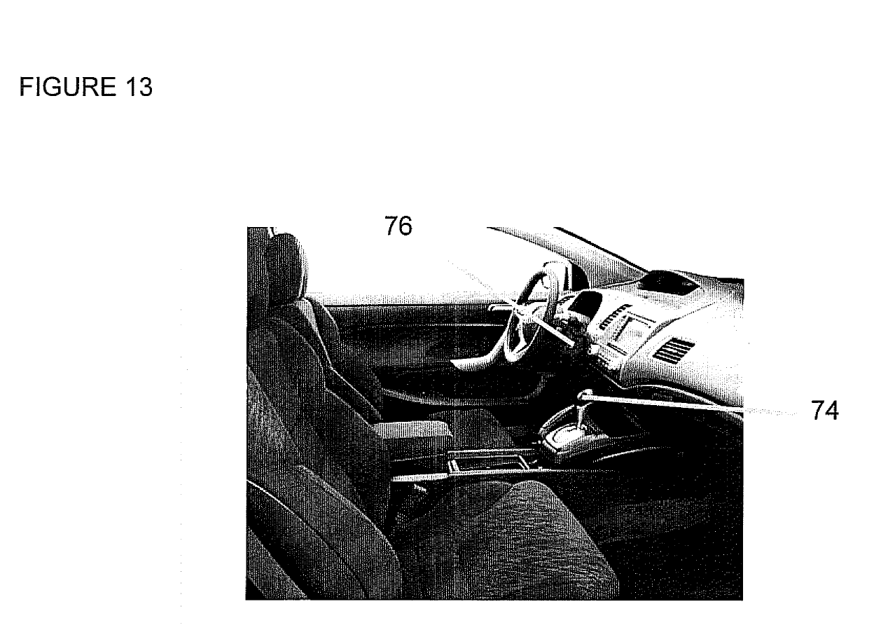

With reference now to FIGS. 3 and 13, the key sensor 5b may be disposed in or near the ignition 76. The key sensor 5b outputs a corresponding detection signal to the control circuit 6 when a vehicle ignition key (not shown) is removed. The collision sensor 5c may detect an impending vehicle collision using any known method for detecting an impending vehicle collision chosen with sound engineering judgment. The collision sensor 5c may output a corresponding detection signal to the control circuit 6 when an impending collision is detected. One example of a vehicle collision detection sensor is shown in U.S. Pat. No. 6,781,511 titled COLLISION DETECTING APPARATUS FOR VEHICLE, which is incorporated herein by reference.

With reference now to FIG. 3, the passenger position sensor 5d may be placed in a vehicle seat cushion or any other location chosen with sound engineering judgment. Other known methods, selected with sound engineering judgment, for detecting passenger position maybe used to determine passenger position. The passenger position sensor 5d may output a corresponding passenger position signal to the control circuit 6 upon detecting passenger position. The passenger position signal may be outputted to the control circuit 6 prior to the motion of the display device 2 from a stored position to an open position. Other embodiments include the passenger position sensor 5d outputting a corresponding passenger position signal to the control circuit 6 upon the detection of any change in passenger position. The signal output portion 5e may be incorporated into any well-chosen vehicle-mounted electronic equipment (such as equipment that includes a TV or DVD) that displays video. The signal output portion 5e may serve as an equipment status detection portion for detecting the status of vehicle-mounted electronic equipment and outputs to the control circuit 6 and may output a detection signal to the control circuit 6 as to whether the equipment is in an audio or video mode or whether it is powered ON or OFF via the operation panel 5f.

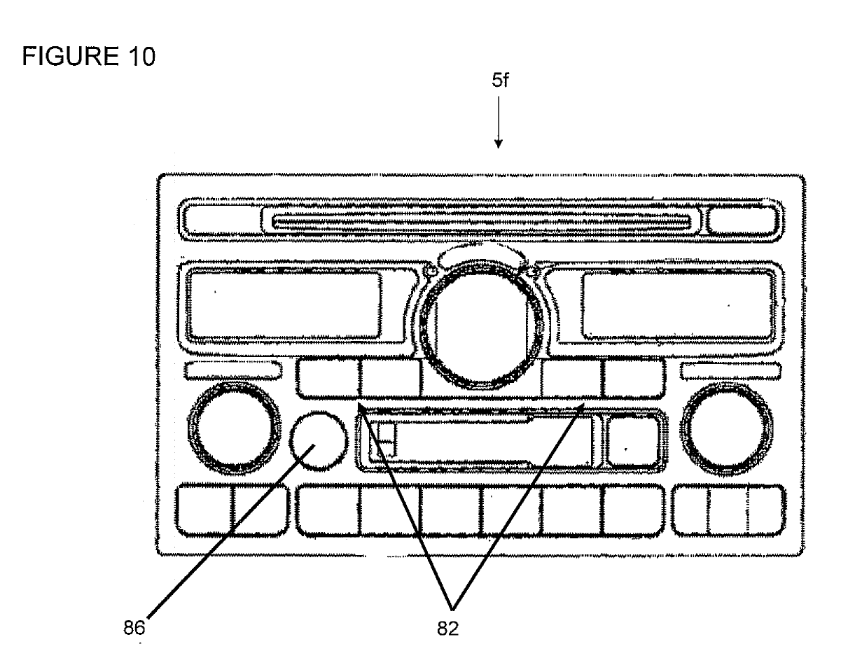

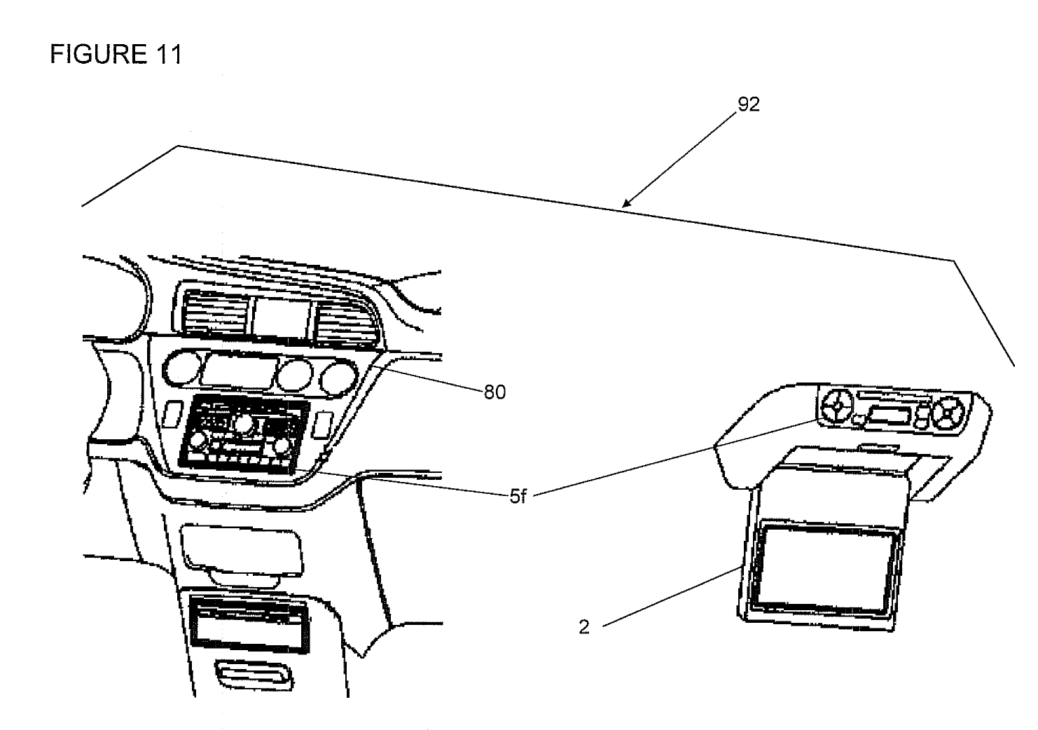

With reference now to FIGS. 3 and 10-12, the operation panel 5f may serve as an operation unit for audio devices and/or audio-visual devices comprising part of the vehicle entertainment system 92. The operation panel 5f may be positioned in a vehicle center console 80 or any other location chosen with sound engineering judgment. The operation panel 5f may be provided with a plurality of buttons, including an audio/video mode selection button 82 for the selection of specific devices, a power selection button 84 that allows an operator to toggle on or off the power supply of the vehicle-mounted electronic equipment and a display device operation button 86 for giving an instruction to open or close the display device 2. The operation panel 5f may comprise a touch panel or any other device chosen with sound engineering judgment that allows the user, in the same manner as with the buttons, to selectively operate the vehicle-mounted electronic equipment.

With reference now to FIG. 3, conditions under which the display device 2 may be automatically closed will now be described. In one embodiment the reverse sensing system 5a may detect that the vehicle has been put in reverse or that a transmission reverse gear has been engaged. The reverse sensing system 5a may output a continuous signal to the control circuit 6 while the reverse gear is engaged. The reverse gear determination portion 61 may determine if the vehicle has been in reverse for a period of time greater than a predetermined value. If the reverse gear determination portion 61 does determine that the reverse gear is engaged for a period of time greater than a predetermined value, the close operation instructing portion 64 may then output a signal to the driving mechanism 4 in order to initiate the movement of display device 2 into a closed position.

With continuing reference to FIG. 3, in one embodiment the collision sensor 5c may output a variable signal at a predetermined interval to the control circuit 6. The impending vehicle collision determination portion 67 may determine from the outputted signal that a vehicle collision is imminent and the close operation instructing portion 64 may then output a signal to the driving mechanism 4 in order to initiate the movement of display device 2 into a closed position.

With reference now to FIGS. 1-3 and 9, the close operation instructing portion 64 may control the operation of the motor 26 using an opening relay 44 and a closing relay 46. The motor 26 may further comprise a direct current (DC) motor (not shown) mechanically coupled to the display device 2 such that the display device 2 may be driven up to a closed or stowed position when a positive DC voltage is applied across the motor terminals. Similarly, the display device 2 may be driven down or into an open position when a negative DC voltage is applied across the motor terminals. The opening relay 44 and the closing relay 46 each may include a trigger terminal coupled to a inductive coil, a pole terminal coupled to the pole of a switch and a pair of switch terminals. The opening relay 44 and the closing relay 46 may each be coupled to the CPU 42, with the opening relay 44 having a pole terminal coupled to one of the motor terminals and the closing relay 46 having a pole terminal coupled to the other one of the motor terminals. A first switch terminal of the opening relay 44 and the closing relay 46 may be coupled to a DC voltage source, and a second switch terminal may be coupled to ground through transistor 45.

With continuing reference to FIGS. 1-3 and 9, the motor 26 may include an annular magnet and a rotary shaft wherein the annular magnet is mounted on the rotatary shaft of the motor 26. The Hall sensor interface 48 may be coupled to the sensor elements 54a, 54b that may be disposed around the magnet and spaced apart from each other by approximately 90 degrees. The Hall sensor elements 54a, 54b may detect the poles of a magnet to generate electrical currents. As the magnet rotates, the Hall sensor elements 54a, 54b provide pulse signals having a frequency corresponding to the velocity of rotation of the magnet. The Hall sensor interface 48 receives the pulse signals from the Hall sensor elements 54a, 54b and provides signals to the anti-pinch determination portion 66 corresponding to the velocity and direction of movement of the magnet and hence the velocity and direction of movement of the display device 2. The anti-pinch determination portion 66 uses the velocity and direction information to determine whether an object has become lodged between the display device 2 and the base 12, that is, a “pinched” condition. If the anti-pinch determination portion 66 detects a “pinched” condition, further closing of the display device 2 is halted and the motor 26 may be stopped or the open operation instructing portion 65 may output a signal to the driving mechanism 4 in order to initiate the movement of display device 2 into an open position. One example of an anti-pinch sensor is provided in U.S. Pat. No. 6,051,945 titled ANTI-PINCH SAFETY SYSTEM FOR VEHICLE CLOSURE DEVICE, which is incorporated herein by reference. Any known method for determining the existence of a pinch condition, chosen with sound engineering judgment, may be used.

Various embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

We claim:

1. A method comprising the steps of:
(a) providing a vehicle with a closable display device comprising a means for determining the presence of an impediment to closure of the closable display device;
(b) initiating closure of the closable display device; and,
(c) automatically closing the closable display device only if the presence of an impediment to closure is not detected during the automatic closing of the closable display device.

2. The method of claim 1 wherein step (a) comprises the step of:
providing the vehicle with an integrated closable display device.

3. The method of claim 1 wherein step (a) comprises the step of:
providing the vehicle with an entertainment system that comprises the closable display device.

4. The method of claim 1 wherein step (a) comprises the step of:
sensing a passenger position in the vehicle and opening the closable display device to a predetermined position based upon the sensed passenger position.

5. The method of claim 1 wherein step (c) comprises the step of:
automatically closing the closable display device unless the change in velocity of the display device measured by a sensor that detects a rotational rate of an electric motor is less than a predetermined limit.

6. The method of claim 1 wherein step (c) comprises the step of:
automatically closing the closable display device through the use of a motor unless an applied motor torque exceeds a predetermined limit.

7. The method of claim 1 wherein:
step (a) comprises the step of providing the vehicle with an entertainment system that comprises an integrated closable display device;
step (b) comprises the step of initiating closure of the closable display device by operating a remote control device; and,
step (c) comprises the step of automatically closing the closable display device unless the change in velocity of the display device measured by a sensor that detects a rotational rate of an electric motor is less than a first predetermined limit or a motor torque exceeds a second predetermined limit.

8. A method comprising the steps of:
(a) providing a vehicle with a closable display device;
(b) sensing an impending vehicular collision; and,
(c) automatically closing the closable display device.

9. The method of claim 8 wherein step (a) comprises the step of:
providing the vehicle with an entertainment system that comprises the closable display device.

10. The method of claim 8 wherein step (a) comprises the step of:
providing the vehicle with an entertainment system that comprises an audio-visual device and the closable display device.

11. The method of claim 8 wherein step (b) comprises the step of:
using a sensor attached to the vehicle to detect an impending vehicular collision.

12. The method of claim 8 wherein step (c) comprises the step of:
automatically applying at least a first torque to pivot the closable display device into a closed position.

13. The method of claim 8 wherein step (c) comprises the step of:
automatically causing an electric motor assembly to apply at least a first torque to pivot the closable display device into a closed position.

14. A method comprising the steps of:
(a) providing a vehicle with a closable display device;
(b) detecting that the vehicle is being placed in reverse; and,
(c) automatically closing the closable display device if the vehicle has been in reverse for at least a predetermined time period.

15. The method of claim 14 wherein step (a) further comprises the step of:
providing the vehicle with an entertainment system that comprises the closable display device.

16. The method of claim 14 wherein step (a) comprises the step of:
providing the vehicle with an entertainment system that comprises an audio-visual device and the closable display device.

17. The method of claim 14 further comprising the step of:
averting the closing of the closable display device if the vehicle has been in reverse for less than the predetermined time period.

18. The method of claim 14 wherein step (b) comprises the step of:
detecting the vehicle being put in reverse at least in part by determining the position of a gear shift lever.

19. The method of claim 14 wherein step (c) comprises the step of:
automatically applying at least a first torque to pivot the closable display device into a closed position only if the vehicle has been in reverse for at least a predetermined time period.

20. The method of claim 14 wherein step (c) comprises the step of:
automatically causing an electric motor assembly to apply at least a first torque to pivot the closable display device into a closed position only if the vehicle has been in reverse for at least a predetermined time period.
